(19) United States
(12) Patent Application Publication
(10) Pub. No.: US 2020/0281699 A1
(43) Pub. Date: Sep. 10, 2020

(54) DENTAL SCANNING SYSTEM

(71) Applicant: FARO Technologies, Inc., Lake Mary, FL (US)

(72) Inventors: Alessandro Patrioli, Brescia (IT); Matteo Carocci, Brescia (IT); Michele Belotti, Brescia (IT)

(21) Appl. No.: 16/801,452

(22) Filed: Feb. 26, 2020

Related U.S. Application Data
(60) Provisional application No. 62/813,424, filed on Mar. 4, 2019.

(51) Int. Cl. A61C 9/00; A61C 5/77; A61C 13/34

(52) U.S. Cl. CPC A61C 9/0053; A61C 13/34; A61C 5/77

(57) ABSTRACT

A dental scanning system and a method of visualizing and simulating the outcome of a dental procedure is provided. The system and method allows for the registration of scan data of the patient's face with scan data of the patients teeth. This allows for visualization and simulation of the outcome of a dental procedure. The system may include a device having a paddle with retroreflective targets that is held in the patient's mouth. The system may further include a helmet with retroreflective targets. The device and paddle is used in combination with a model of the user's teeth to register scans of the teeth models to the scans of the patient's face.

### CROSS REFERENCE TO RELATED APPLICATIONS

This application claims the benefit of U.S. Provisional Application Ser. No. 62/813,424, filed Mar. 4, 2019, the entire disclosure of which is incorporated herein by reference.

### BACKGROUND

The subject matter disclosed herein relates to a dental scanning system, and in particular to a dental scanning system that provides visualization and simulation of an outcome of a dental procedure.

### BRIEF DESCRIPTION

According to one aspect of the disclosure a dental scanning system is provided that allows for the registration of scan data of the patient's face with scan data of the patients teeth. This allows for visualization and simulation of the outcome of a dental procedure. The system may include a device having a paddle with retroreflective targets that is held in the patient's mouth. The system may further include a helmet with retroreflective targets. The device and paddle is used in combination with a model of the user's teeth to register scans of the teeth models to the scans of the patient's face.

According to another aspect of the disclosure, a method of providing visualization and simulation of a dental procedure is provided. The method includes in a first instance, scanning a patients face with a three-dimensional (3D) scanning device to generate a first point cloud. A device is inserted in the patients mouth, the device having a tray with an impression material disposed thereon, a paddle is operably coupled to the tray, the paddle having a plurality of targets thereon. In a second instance, the patients face is scanned with the 3D scanning device with the device inserted to generate a second point cloud. In a third instance, a model of the patients teeth is scanned with the 3D scanning device based at least in part on the impression material to generate a third point cloud. The third point cloud is registered to the first point cloud based at least in part on the second point cloud. The registered third point cloud and first point cloud is displayed on a display.

In addition to one or more of the features described herein, or as an alternative, further embodiments of the method may include inserting the device onto the model; and in a fourth instance, scanning the model and the device and generating a fourth point cloud; wherein the registering of the third point cloud and first point cloud is further based at least in part on the fourth point cloud. In addition to one or more of the features described herein, or as an alternative, further embodiments of the method may include placing a helmet on the patients head after scanning the patients face with the device inserted, the helmet having at least one member having a plurality of targets; in a fifth instance, scanning the patient and the helmet to generate a fifth point cloud; and wherein the registering of the third point cloud and the first point cloud is based at least in part on the fifth point cloud.

In addition to one or more of the features described herein, or as an alternative, further embodiments of the method may include affixing an arm to at least one tooth, the arm having a second paddle with a plurality of targets thereon. In addition to one or more of the features described herein, or as an alternative, further embodiments of the method may include moving the patients jaw; and scanning the patient and the second paddle while the patients jaw is moving to determine the position of the second paddle during movement. In addition to one or more of the features described herein, or as an alternative, further embodiments of the method may include the second paddle is the paddle.

In addition to one or more of the features described herein, or as an alternative, further embodiments of the method may include the movement of the jaw is a movement to one or more of directions comprising: a lateral right; a lateral left; a protrusion, a retrusion, a mouth opening, or a free movement. In addition to one or more of the features described herein, or as an alternative, further embodiments of the method may include the registration of the third point cloud to the first point cloud is based at least in part on at least one of a best fit based on natural features and an Iterative Closest Point (ICP) method.

In accordance with another embodiment of the disclosure, a system for visualization and simulation of a dental procedure for a patient is provided. The system includes a 3D scanner configured to optically measure coordinates on surfaces to generate a point cloud. A device is provided having a tray and a paddle, the tray having an impression material, the paddle having a plurality of targets thereon. One or more processors are responsive to executable computer instructions for performing a method comprising: in a first instance, scanning the patients face with the 3D scanning device to generate a first point cloud; inserting the device in the patients mouth; in a second instance, scanning the patients face with the device inserted to generate a second point cloud; in a third instance, scanning a model of the patients teeth based at least in part on the impression material to generate a third point cloud; registering the third point cloud to the first point cloud based at least in part on the second point cloud; and displaying the registered third point cloud and first point cloud on a display.

In addition to one or more of the features described herein, or as an alternative, further embodiments of the system may include a method that further comprises: in a fourth instance, scanning the model with the device inserted on the model and generating a fourth point cloud; and wherein the registering of the third point cloud and first point cloud is further based at least in part on the fourth point cloud. In addition to one or more of the features described herein, or as an alternative, further embodiments of the system may include a helmet sized to fit on the patients head, the helmet having at least one member with a plurality of targets disposed thereon; wherein the method further comprises: in a fifth instance, scanning the patient and with the helmet disposed on their head to generate a fifth point cloud; and wherein the registering of the third point cloud and the first point cloud is based at least in part on the fifth point cloud.

In addition to one or more of the features described herein, or as an alternative, further embodiments of the system may include an arm a first end and a second end, the first end being configured to attach to a tooth of the patient, the second end being attached to a second paddle, the second paddle having a plurality of targets thereon. In addition to one or more of the features described herein, or as an alternative, further embodiments of the system may include a method that further comprises: scanning with the 3D scanner the patient and the second paddle while the patient moves their jaw; and determining the position of the second paddle while the patient moves their jaw. In addition to one or more of the features described herein, or as an alternative, further embodiments of the system may include the movement of the jaw being a movement to one or more directions comprising: a lateral right; a lateral left; a protrusion, a retrusion, a mouth opening, or a free movement.

In addition to one or more of the features described herein, or as an alternative, further embodiments of the system may include the registration of the third point cloud to the first point cloud being based at least in part on at least one of a best fit based on natural features and an Iterative Closest Point (ICP) method.

In accordance with another embodiment of the disclosure a method of providing visualization and simulation of a dental procedure is provided. The method includes scanning with a noncontact 3D scanner the patients face at rest to generate a first point cloud. The patients face in a smiling position is scanned with the noncontact 3D scanner to generate a second point cloud. A device is inserted in the patients mouth, the device having a tray with a first impression material disposed thereon, the tray being disposed against the patients upper jaw, a paddle is operably coupled to the tray, the paddle having a plurality of targets thereon. The patients face is scanned with the tray disposed on the patients upper jaw to generate a third point cloud. The device is inserted in the patients mount with tray having a second impression material disposed thereon, the tray being disposed against the patients lower jaw. The patients face is scanned with the noncontact 3D scanner with the tray disposed on the patients lower jaw to generate a fourth point cloud. A first physical model of the patients teeth is generated based in part on the first impression material. A second physical model of the patients teeth is generated based in part on the second impression material. The first physical model is scanned with the 3D scanner to generate a fifth point cloud. The second physical model is scanned with the 3D scanner to generate a sixth point cloud. A combination of the first physical model and second physical model are scanned with the 3D scanner to generate a seventh point cloud. The first point cloud and the second point cloud are registered based at least in part on the third point cloud and the fourth point cloud. The fifth point cloud and sixth point cloud are registered based at least in part on the seventh point cloud. The registered first point cloud and the second point cloud are registered with the registered fifth point cloud and sixth point cloud. The registered first point cloud, second point cloud, fifth point cloud and sixth point cloud are displayed on a display.

In addition to one or more of the features described herein, or as an alternative, further embodiments of the method may include scanning a combination of the first physical model and second physical model with the tray operably disposed on one of the upper jaw or lower jaw with the 3D scanner to generate an eighth point cloud; and wherein the registration of the registered first point cloud and the second point cloud with the registered fifth point cloud and sixth point cloud is based at least in part on the eighth point cloud. In addition to one or more of the features described herein, or as an alternative, further embodiments of the method may include placing a helmet on the patients head after scanning the patients face with the device inserted, the helmet having at least one member having a plurality of targets; scanning the patient and the helmet to generate a ninth point cloud; and wherein the registration of the registered first point cloud and the second point cloud with the registered fifth point cloud and sixth point cloud is further based at least in part on the ninth point cloud.

These and other advantages and features will become more apparent from the following description taken in conjunction with the drawings.

### BRIEF DESCRIPTION OF DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a flow diagram for operating a dental scanning system in accordance with an embodiment;

FIG. 2 is an image of a patient having her face three-dimensionally scanned in a resting face position;

FIG. 3 is an image of the three-dimensional scan of the patient's face;

FIG. 4 is an image of a patient having her face three-dimensionally scanned in a smiling face position;

FIGS. 5-9 are images of the patient being scanned with a fork and paddle coupled to her mouth;

FIG. 10 is an image of the patient with the helmet and paddle installed;

FIG. 11 is an image of a patient with the paddle coupled to their lower jaw;

FIG. 12 is an image of the patient having her face three-dimensionally scanned with the helmet on and the paddle in her mouth;

FIGS. 13-16 are images of the patient moving her mouth while three-dimensionally scanning her face;

FIGS. 18-20 are images of computer software for identifying the patients teeth;

FIG. 21 is an image of a model of the patient's lower jaw and teeth being three-dimensionally scanned.

FIG. 22 is an image of a model of the patients lower jaw and teeth and upper jaw and teeth being three-dimensionally scanned;

FIG. 23 is an image of a model of the patients upper jaw and teeth being three-dimensionally scanned;

FIGS. 24-26 are images of the patients upper jaw and teeth with the paddle and fork disposed thereon being three-dimensionally scanned;

FIGS. 27-31 are images of the three-dimensional scans performed in FIGS. 21-26;

FIG. 32 and FIG. 33 are images of the three-dimensional scans of FIGS. 27-31 being registered and aligned into the same coordinate frame of reference;

FIG. 34 is an image of the three-dimensional scan of the user's face acquired if FIG. 12;

FIG. 35 is an image of the three-dimensional scan of the user's face acquired in FIG. 3;

FIG. 36 is an image of the three-dimensional scan of the user's face acquired in FIG. 2; and

FIG. 37 is a flow diagram in accordance with an embodiment.

The detailed description explains embodiments of the disclosure, together with advantages and features, by way of example with reference to the drawings.

### DETAILED DESCRIPTION

Embodiments of the present disclosure provide advantages in allowing the three-dimensional scanning of a patients face and teeth and the generation of a computer image of the three-dimensional scan. Embodiments of the present disclosure provide advantages in allowing a patient to see a simulated result of a proposed dental procedure. Further embodiments of the present disclosure provide advantages in being able to three-dimensionally measure the movement of the patient's mouth to allow the visual appearance of a dental procedure to be simulated prior to the procedure being performed.

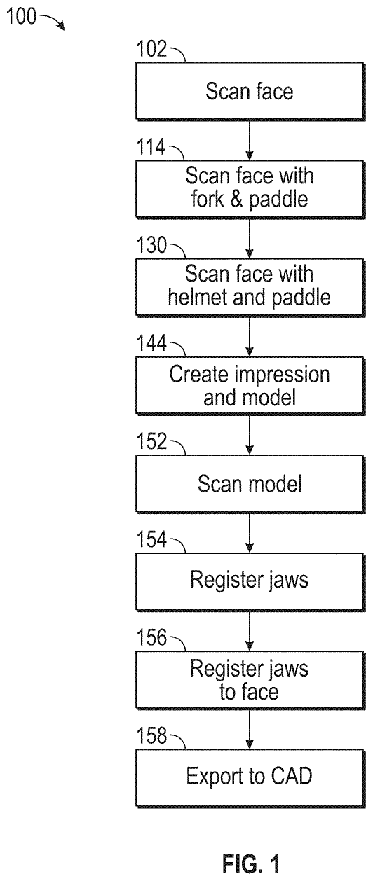

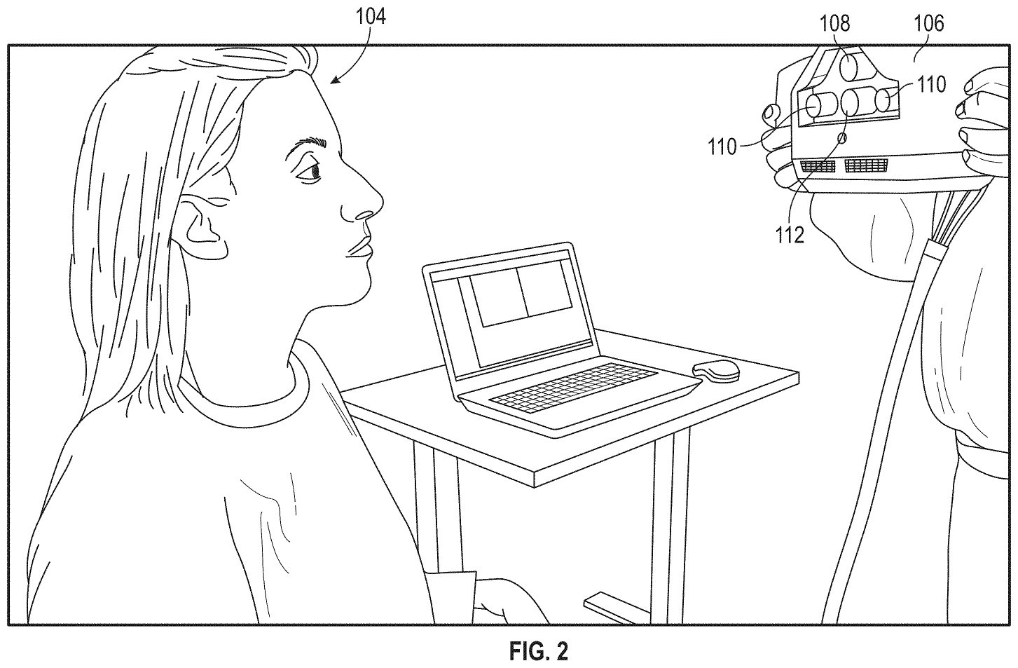

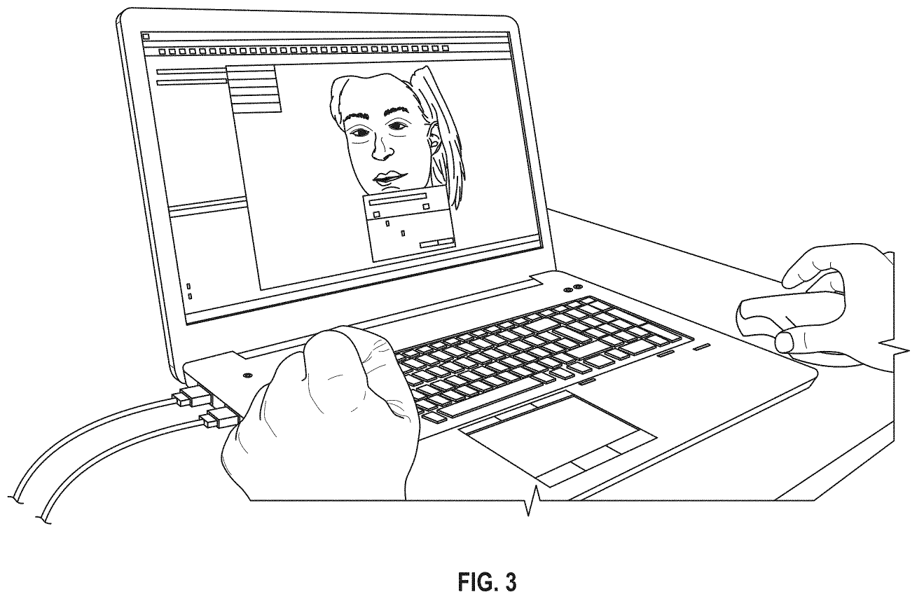

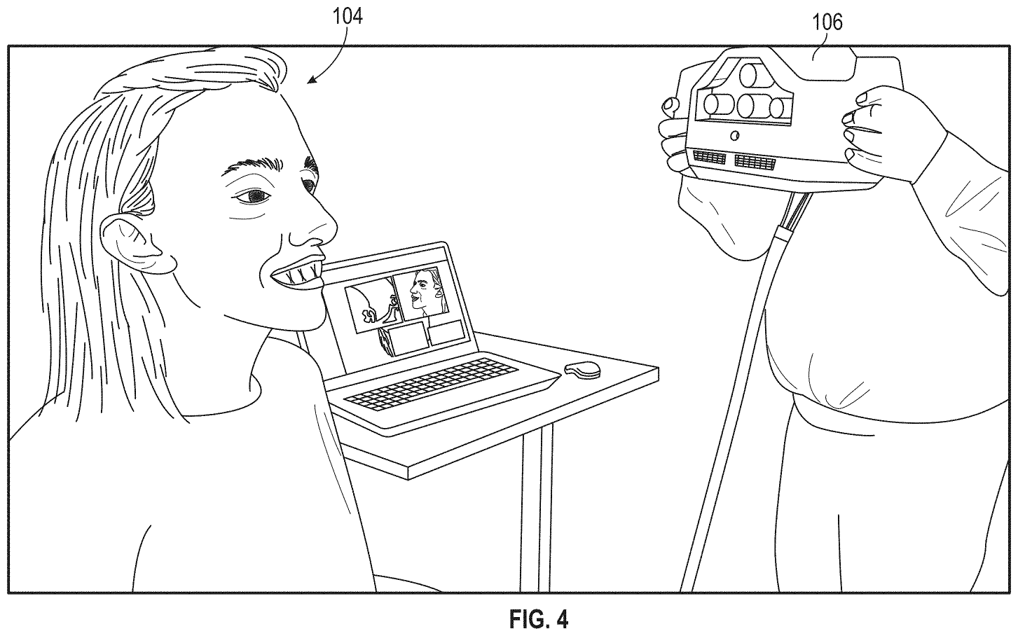

Referring to FIG. 1, a method 100 is shown for scanning a patient's face and teeth to provide a visualization of a proposed dental procedure. The method starts in box 102 where the patients 104 face is scanned with a three-dimensional scanning device 106 (FIG. 2-4), such as a noncontact optical measuring device. Noncontact optical measuring devices may include a triangulation laser scanner such as a scanning device manufactured by FARO Technologies, Inc., of Lake Mary, Fla., USA for example. It should be appreciated that other types of scanning devices, such as but not limited to a time of flight scanner, a structured light scanner, or a phase-based scanner may also be used. In general, a triangulation scanner has a projector 108 that projects a light pattern (i.e. infrared light pattern) on to the person or object being scanned. Images of the light pattern are acquired using a pair of cameras 110. A third camera 112, such as a color camera for example, acquires texture or color information of the person or object. Other types of scanning devices include, but are not limited to laser line scanners, line scanners, flying-dot scanners, and laser line probes.

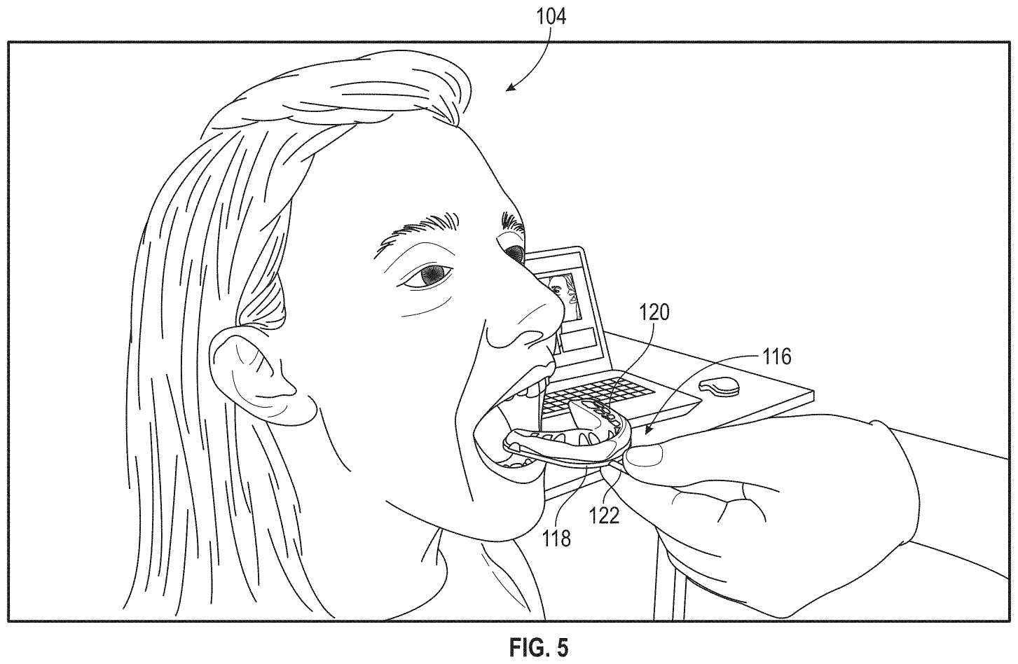

In an embodiment, a first scan of the patient's face may be scanned with the patient's face in a rest position (FIG. 2). A second scan of the patient's face is performed with the patient's face in a smiling position (FIG. 4).

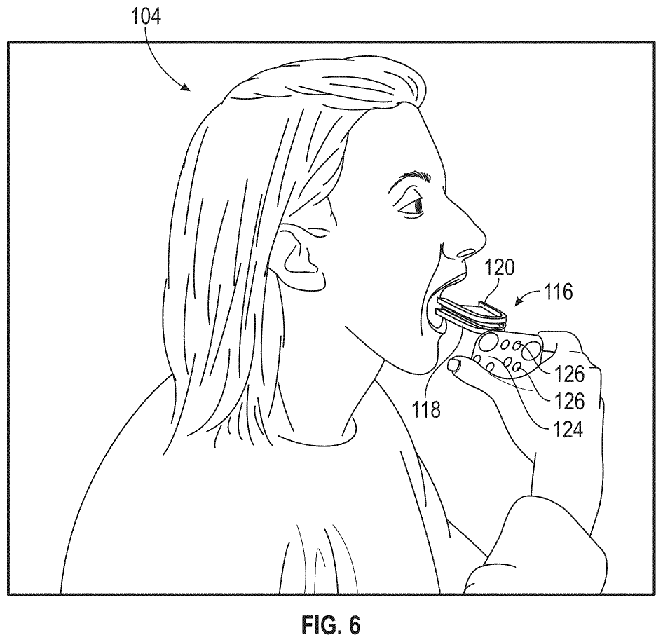

The method 100 then proceeds to block 114 where a device 116 is inserted into the patient's mouth (FIG. 5). In an embodiment, the device includes a tray or body 118 having an impression material, such as silicone material 120 for example, disposed thereon. In an embodiment, the device 116 includes silicone material 120 on both sides of the body 118. The body 118 includes an arm 122 extending from one side. The device 118 is placed in the patient's 104 mouth and their teeth are closed over the device 116 and embedded in the silicone material 120. The arm 122 extends out of the patient's mouth. It should be appreciated that the silicone material 120 allows the body 118 to be securely held in the patient's mouth.

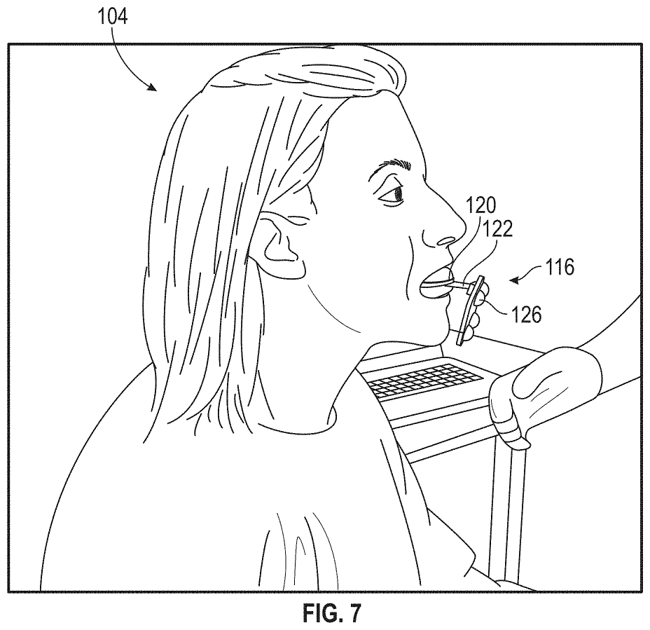

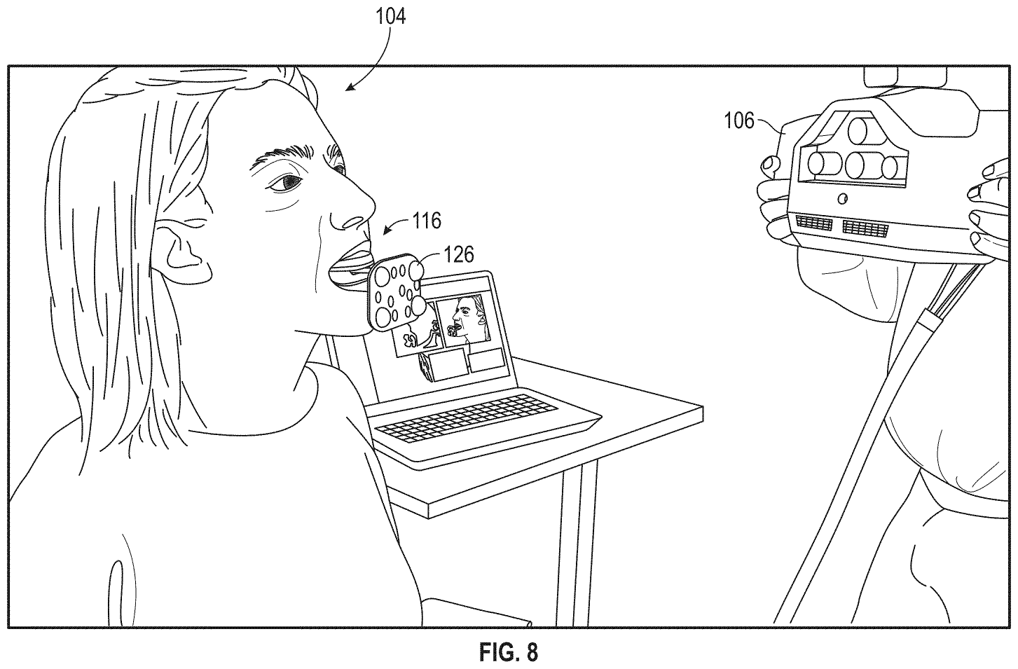

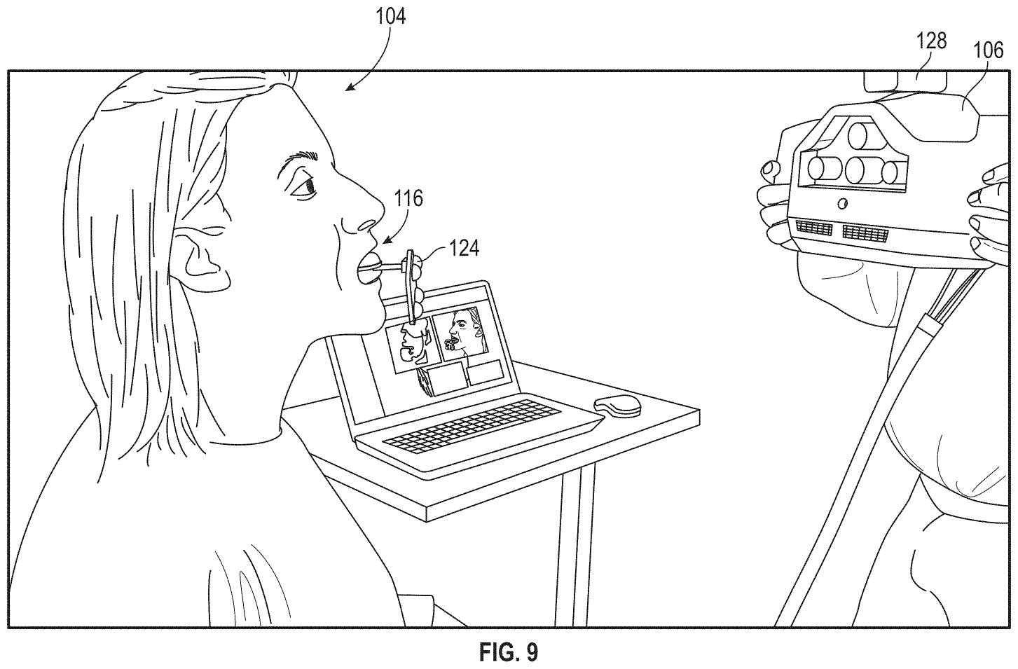

Either prior to insertion of the device 116 (e.g. a fork device) into the patient's mouth or subsequent to insertion, a paddle member 124 (FIGS. 6-9) is coupled to the arm 122. In an embodiment, the paddle 124 includes a plurality of targets, such as reflective dots 126. As will be discussed in more detail herein, in an embodiment the dots 126 allow the three-dimensional measurement of position of the paddle with six degrees of freedom when measured by the scanner 106. In an embodiment, the paddle 124 has a plurality (e.g. four) semi-spherical protrusions extending from a surface facing away from the patient's face. In an embodiment, the semi-spherical protrusions are different sizes.

With the device 116 and the paddle 124 held in the patient's mouth, the scanning device 106 is used to measure the front of the patient's face. In an embodiment, an optional infrared illuminator 128 is coupled to the top of the scanning device 106.

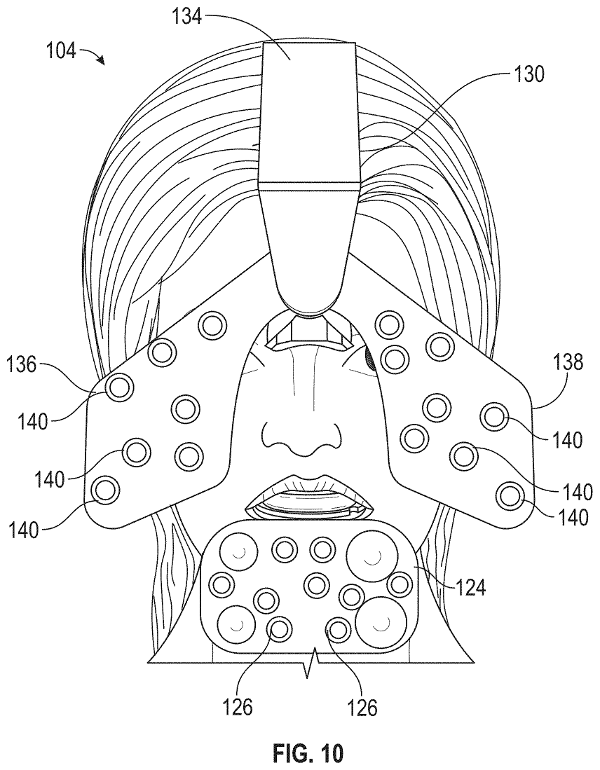

The method 100 then proceeds to block 130 where a helmet device 132 is placed on the patient's head (FIG. 10). The helmet 132 includes an arm 134 that wraps around the top of the patient's head. Extending from the arm 134 is a pair of members 136, 138 that extend on either side of the patient's nose. Each member 136, 138 includes a plurality of targets, such as a plurality of reflective dots 140 for example. The patient's face, with the helmet 132 on their head and the paddle 124 held by the device 116 in the patient's mouth, another three-dimensional scan of the patient's face is performed using the scanner 106.

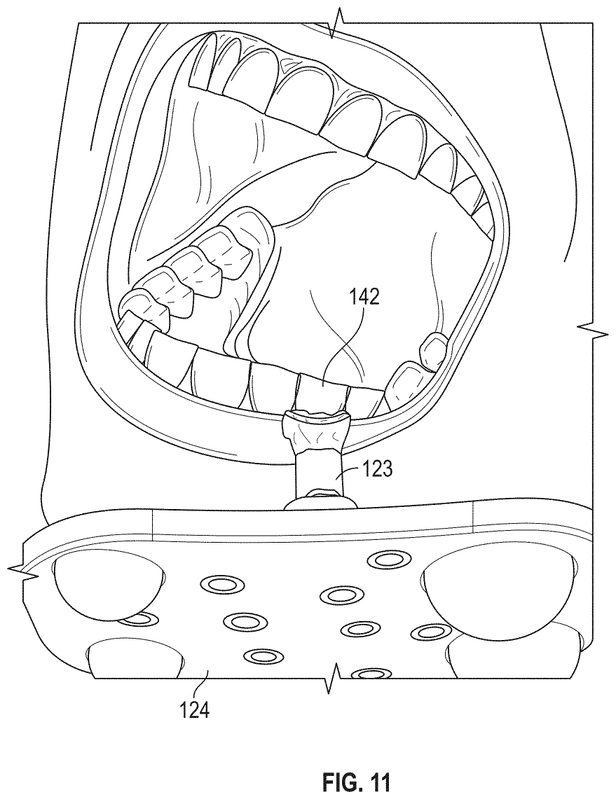

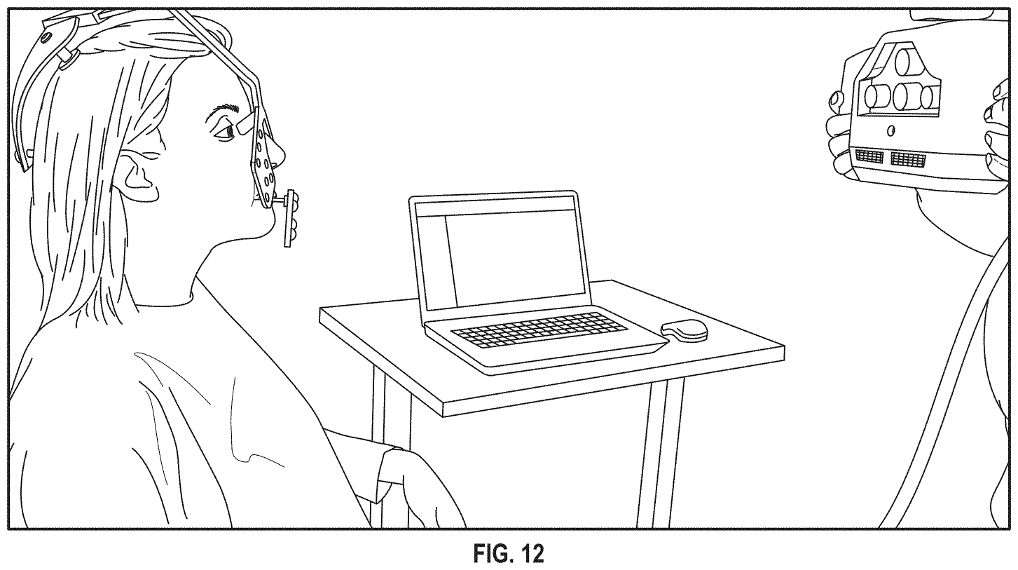

In one embodiment, the device 116 is then removed and the paddle 124 is connected to a tooth 142 (FIG. 11). It should be appreciated that when the paddle 124, when it is attached to the lower tooth or jaw is measured by the scanner 106 (FIG. 12), it may be registered to the earlier performed scans by its position the helmet 132. In one embodiment, it may be desired to measure the movement of the patient's jaw. This may provide advantages in simulating how a particular dental procedure will be impacted when the lower jaw is in different positions. In an embodiment, the measurement of the movement of the users jaw also helps determine where the user's jaw pivots.

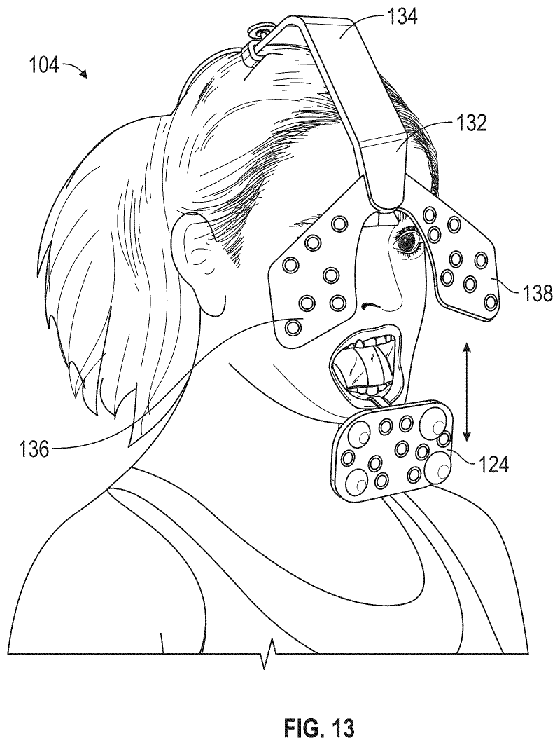

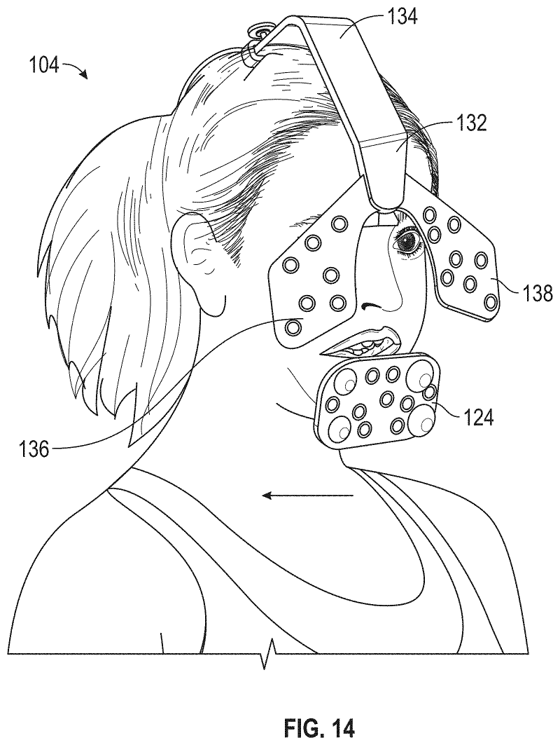

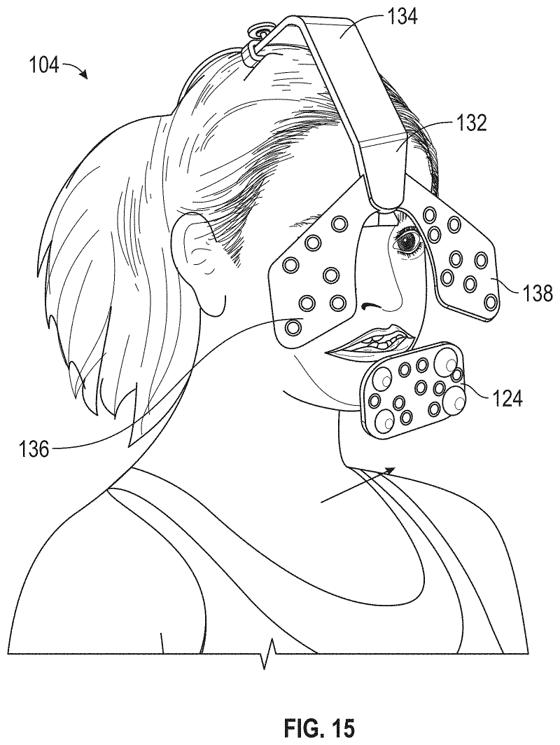

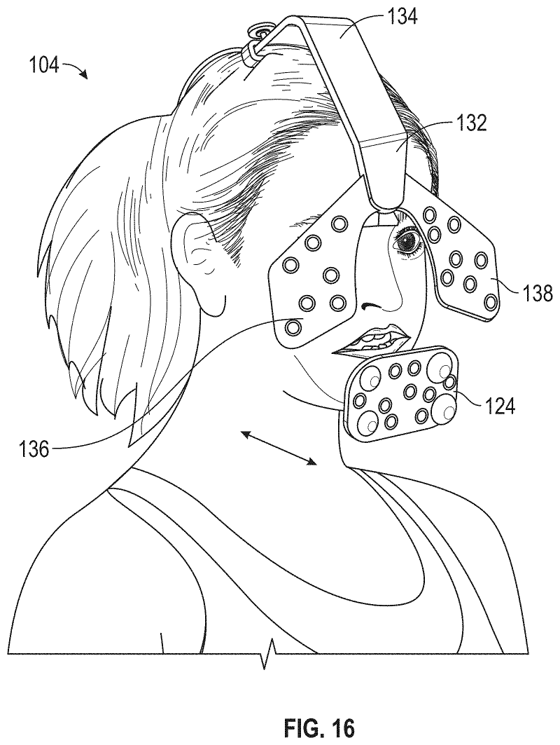

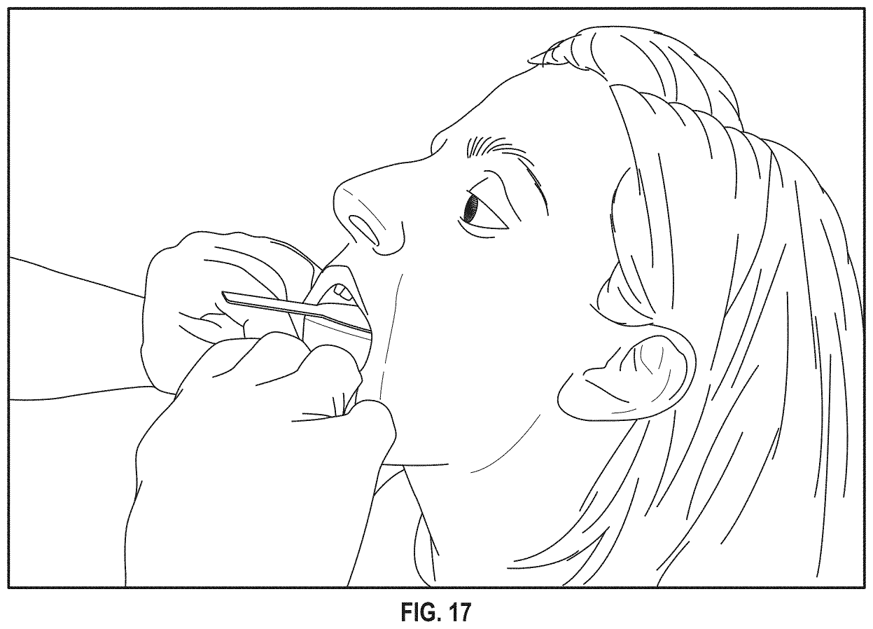

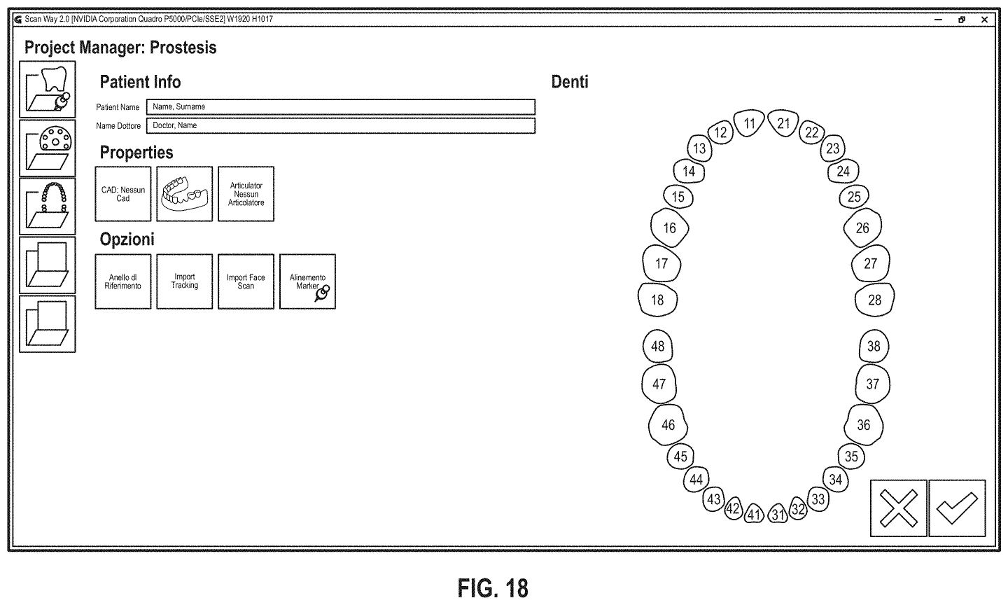

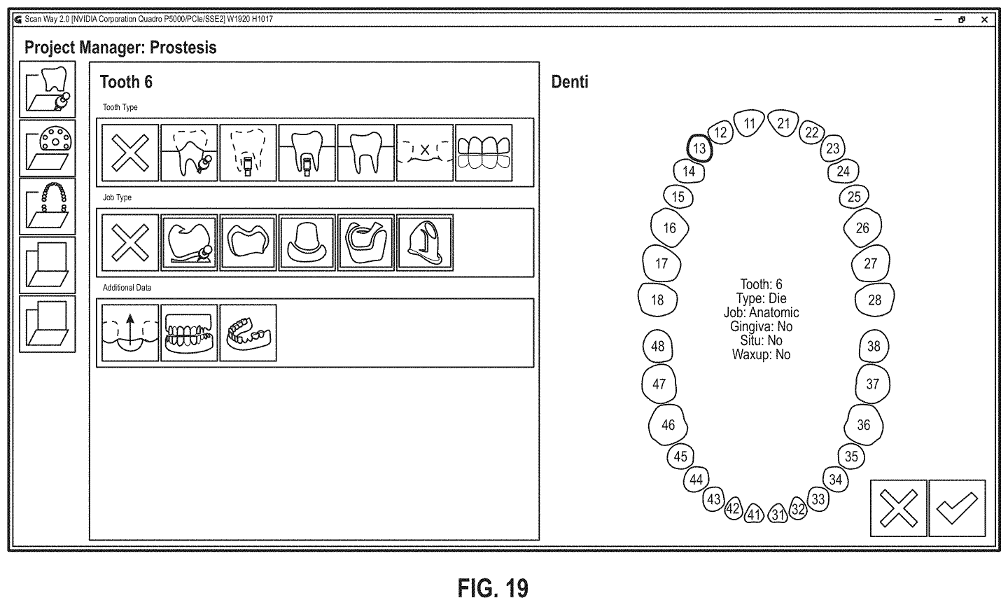

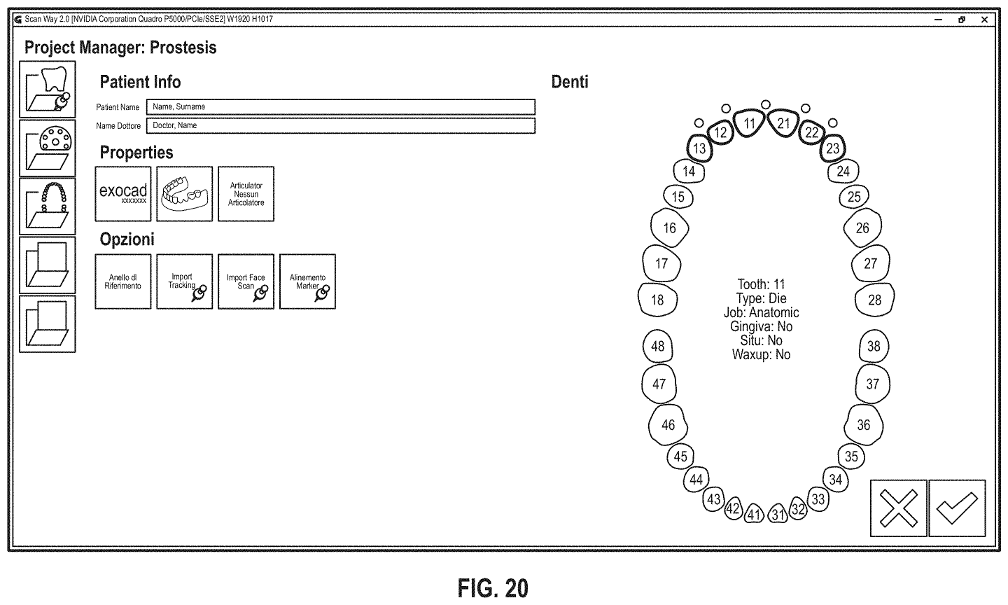

As shown in FIGS. 13-16, the patient moves their jaw in predetermined directions as indicated by the arrows. As the patient moves their jaw, the scanner 106 is used to measure the position(s) of the paddle 124. For example, lateral right; lateral left; protrusion, retrusion, mouth opening, free movement (optional).

When the scanning with the scanner 106 is completed, the measurements, sometimes referred to a point cloud, for each of the scans is saved to memory. The method 100 then proceeds to block 144 where an impression is made of the patients upper teeth and lower teeth (FIG. 17) in a manner as is known in the art. A model is made of the upper teeth 146 and the lower teeth 148 as is known in the art, such as by using plaster for example.

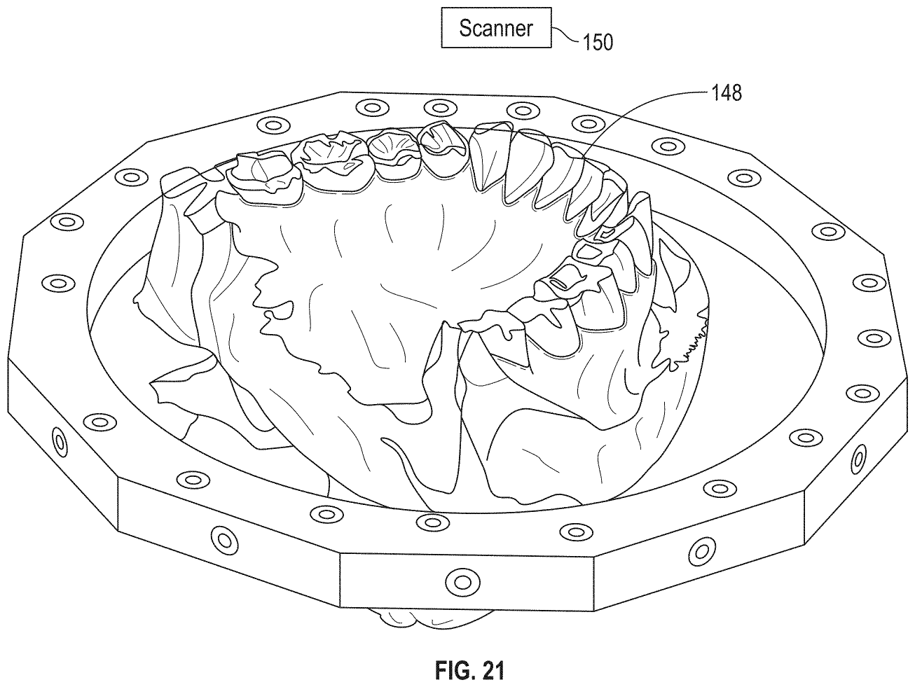

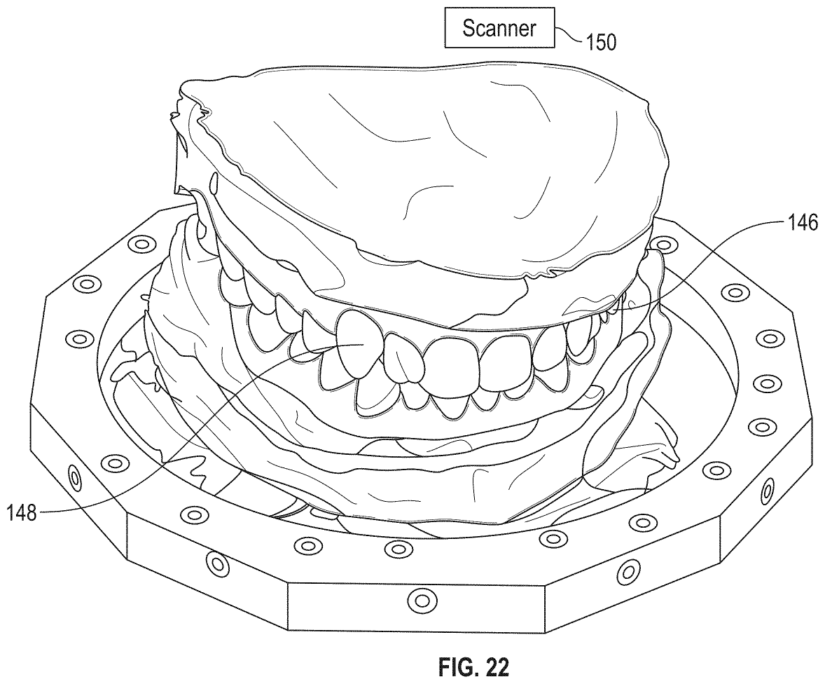

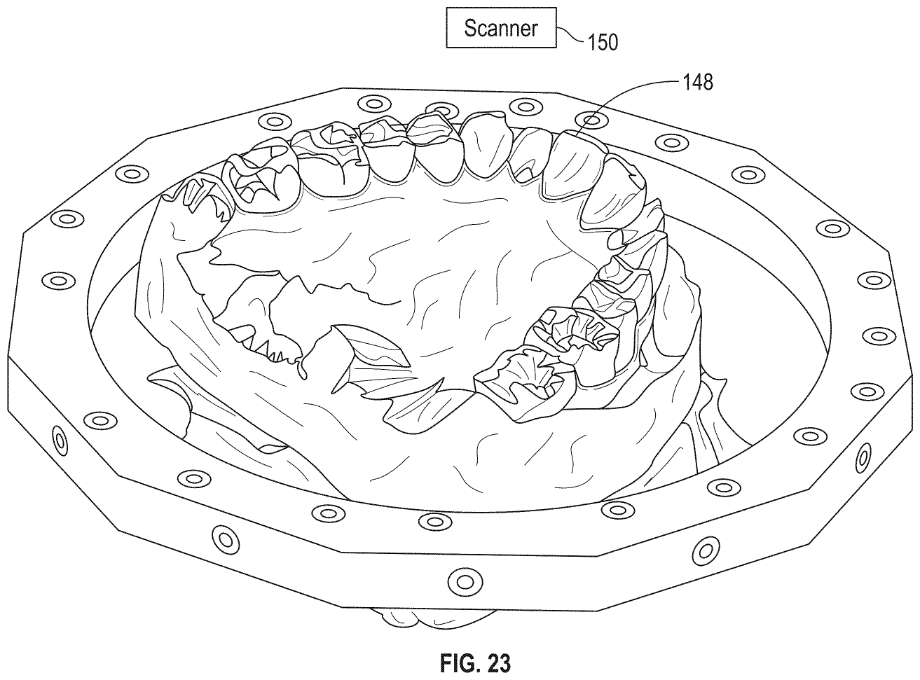

The models 146, 148 are then scanned with a three-dimensional scanner 150 in block 152. The scanner 150 may be a triangulation type optical scanner that includes a bed or platen 154 that may be moved or rotated in a prescribed manner to three-dimensionally measure the models 146, 148. In an embodiment, first the model 148 of the lower teeth are measured with the scanner 150 (FIG. 21). Then the model 146 of upper teeth are placed on the model of the lower teeth 148 and another scan is performed (FIG. 22). Then a third scan of the model 146 of the upper teeth is performed (FIG. 23).

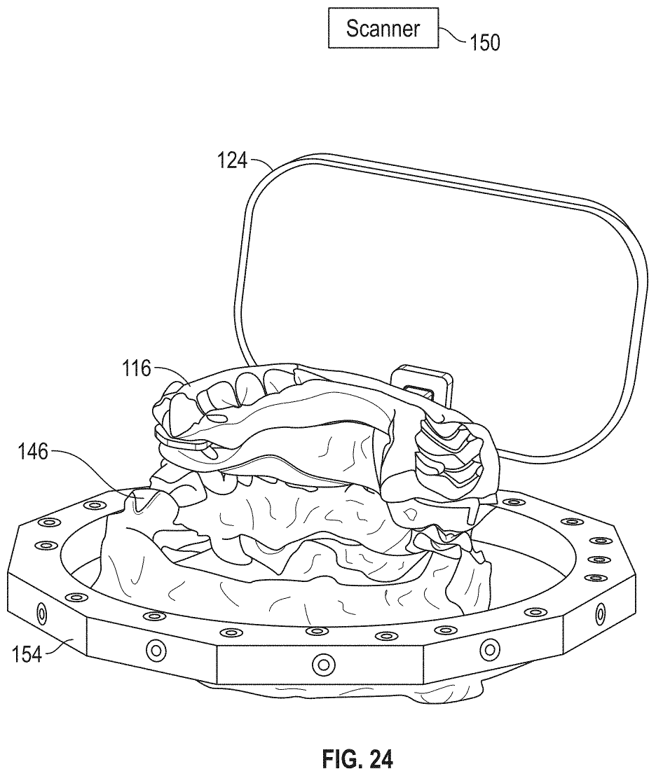

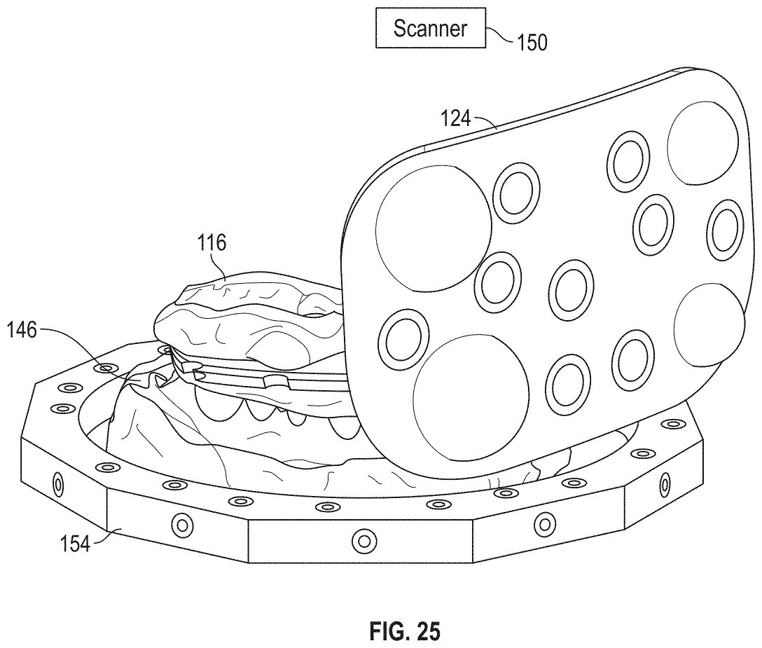

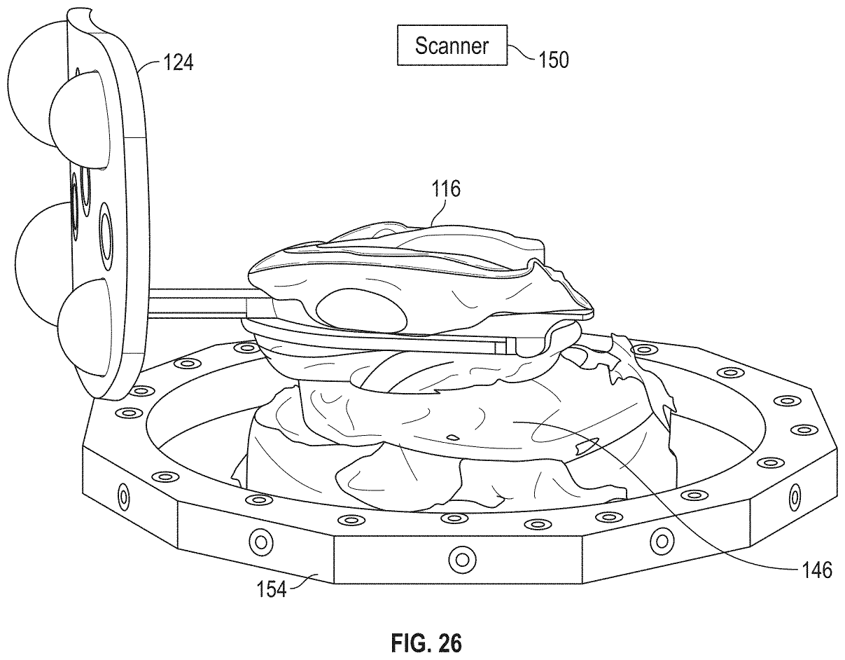

With the model 146 of the upper teeth on the platen 154, the device 116 with the paddle 124 attached is placed on the model 146 of the upper teeth. A fourth scan is performed with the scanner 150 (FIGS. 24-26). It should be appreciated that the scanning of the device 116 with the impressions from the patients teeth from the original scan (FIG. 5) still formed therein allows the paddle 124 to have the substantially the same relative position to the model 146 of the upper teeth as it did to the upper teeth of the patient during the scan of FIG. 5.

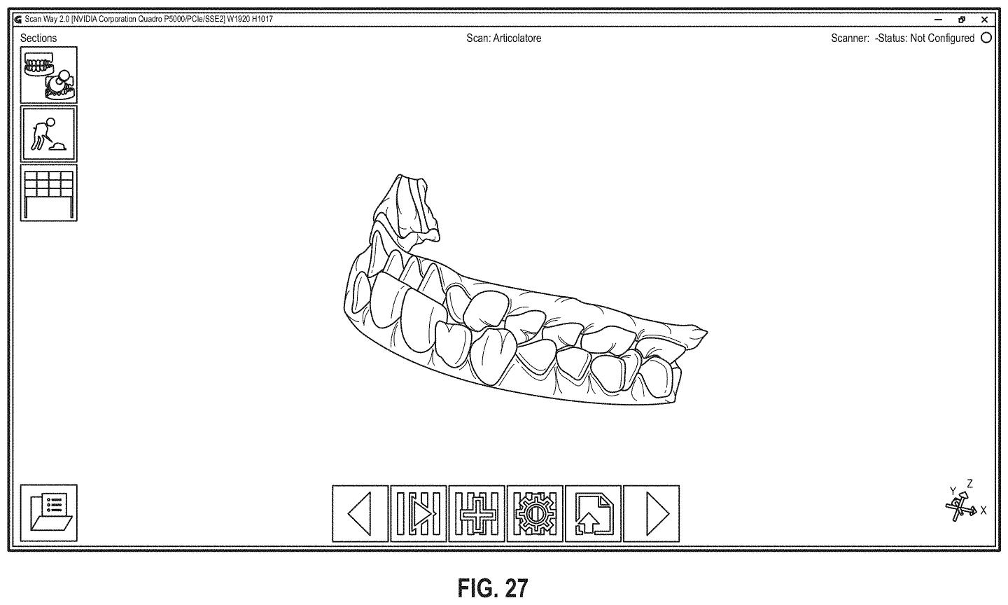

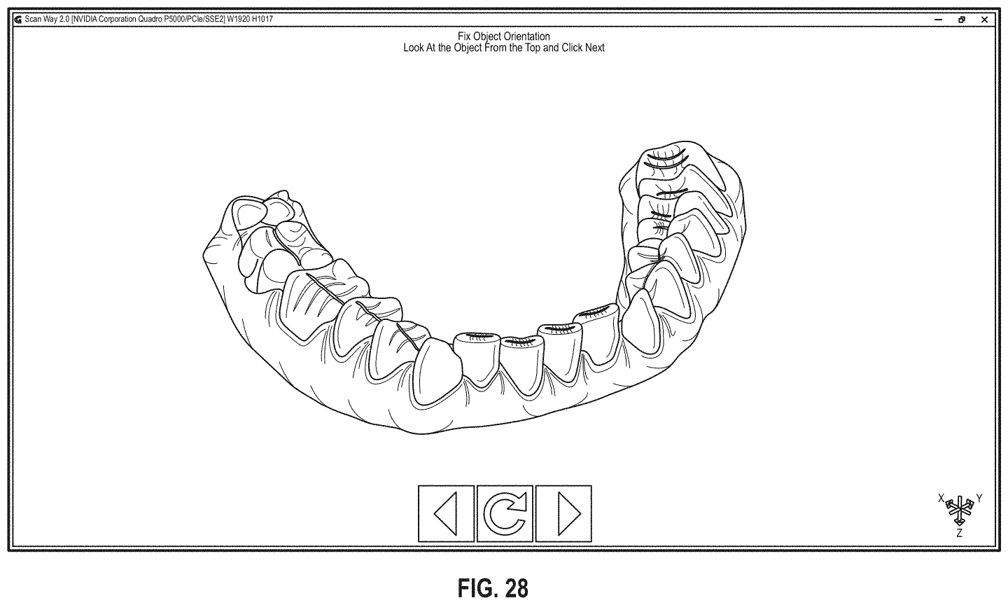

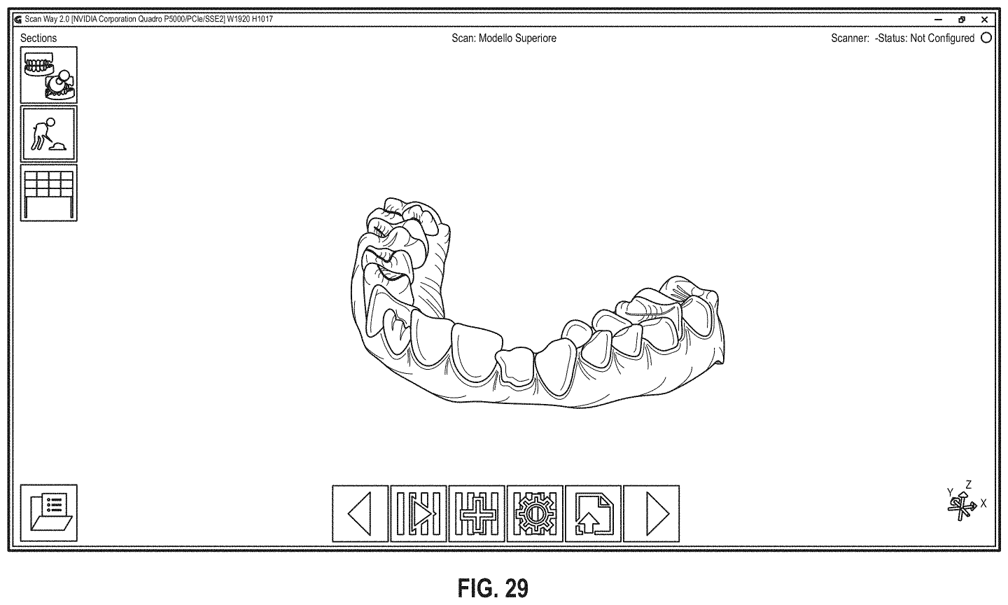

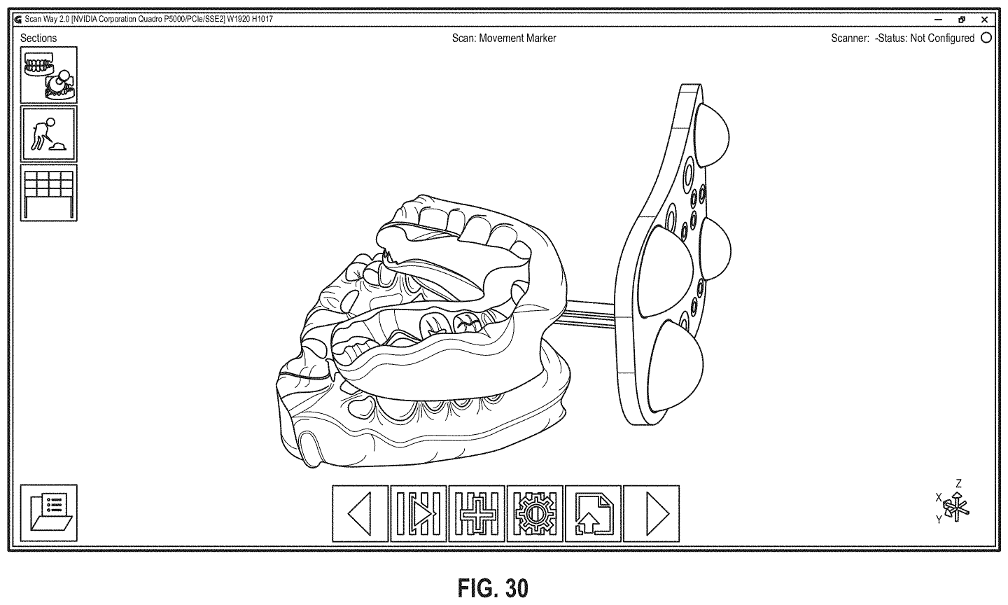

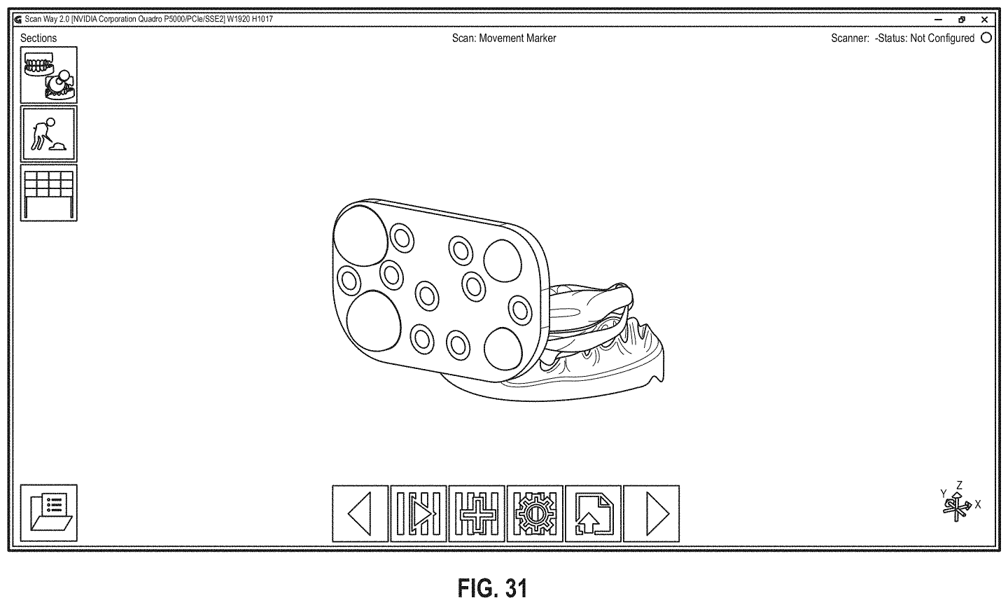

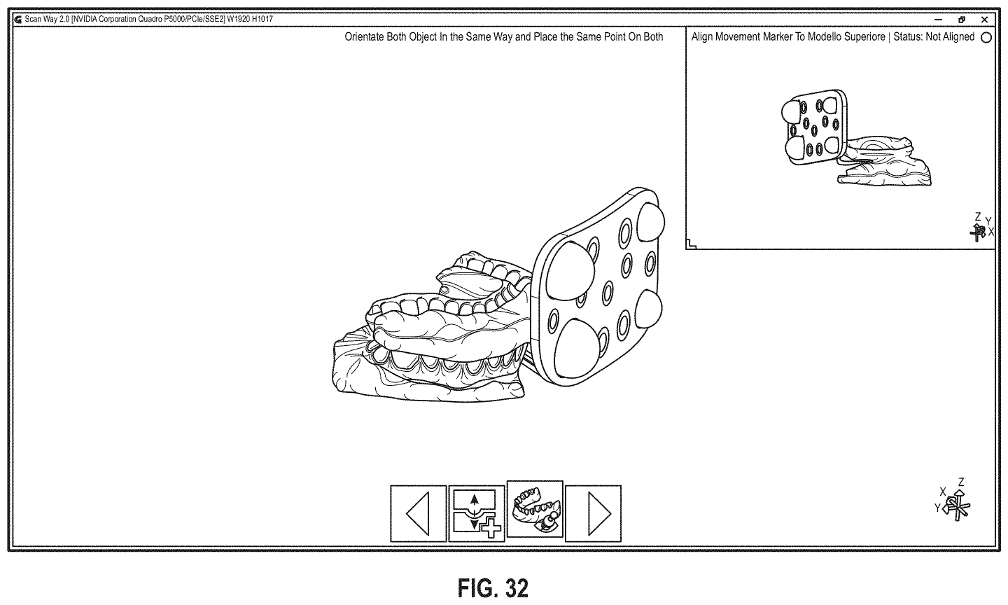

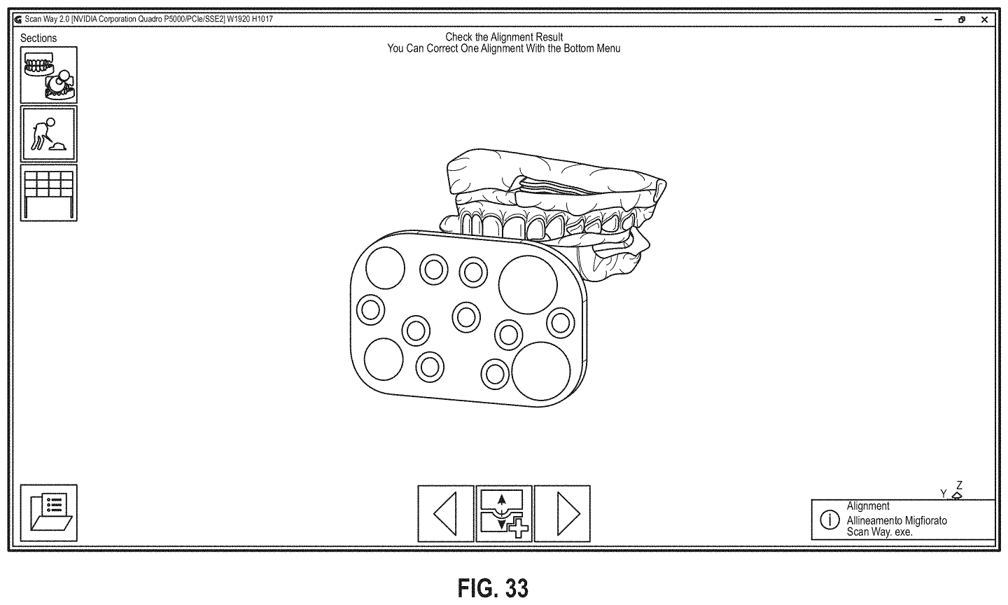

With the scans performed, the method 100 then proceeds to block 154 where the scans or point clouds of the models 146, 148 and the model 146 with the device 116/paddle 124 are registered together (FIGS. 27-33). In an embodiment, the registration is a best fit based on natural features of the scan data. In another embodiment, the scans may be registered together using an Iterative Closest Point (ICP) methodology.

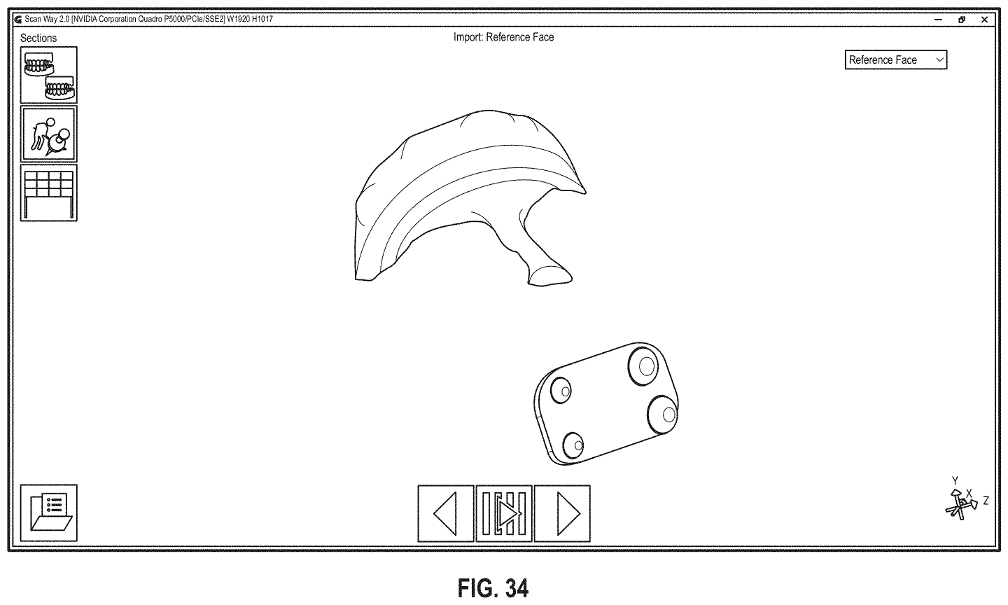

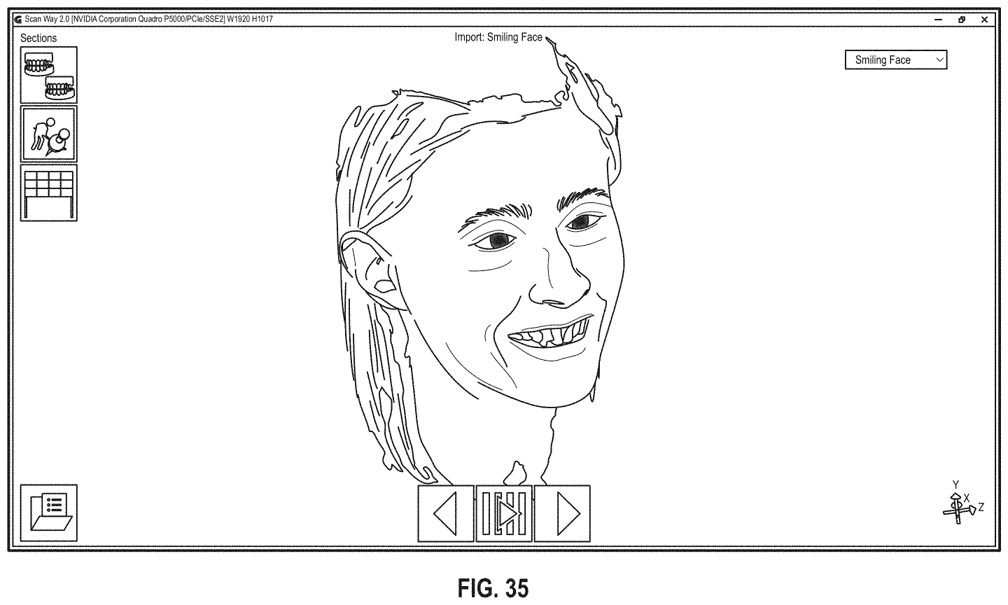

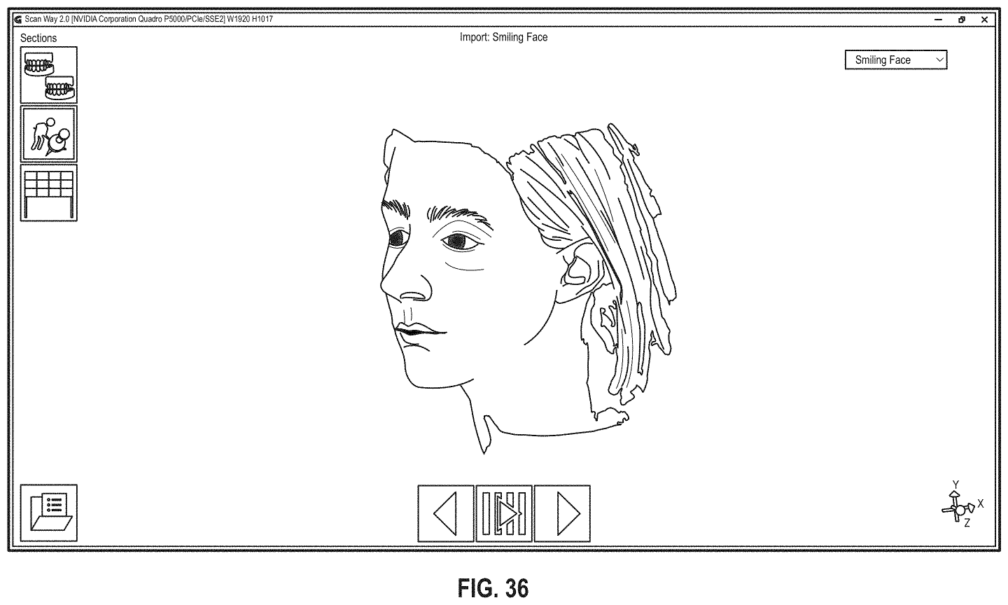

With the scans of the models 146, 148 and the model 146 with the device 116/paddle 124 are registered together, the method 100 proceeds to block 156. In an embodiment, the scans of the patients face from FIG. 2, FIG. 4, and FIG. 10 are registered together using a best fit or ICP methodology as shown in FIGS. 34-36. Since the scan data from FIG. 10 includes the paddle 124, the scans of the models 146, 148 and the model 146 with the device 116/paddle 124 may then be registered to the scans of the patient's face. Thus the scan data of the models of the patient's upper and lower teeth 146, 148 may be “placed” in the scan data of the of the user's face.

In an embodiment, the method 100 may proceed to block the registered scan data (patient's face, models 146, 148) may be exported to a dental CAD system in block 158, such as ExoCAD for example. In an embodiment, the movement data from FIGS. 13-16 may be included in the data export to allow the movement of the jaw to be simulated. It should be appreciated that the CAD system may be then used to simulate, design, display, and visualize a dental procedure and the patient may be shown the how the procedure will look when completed.

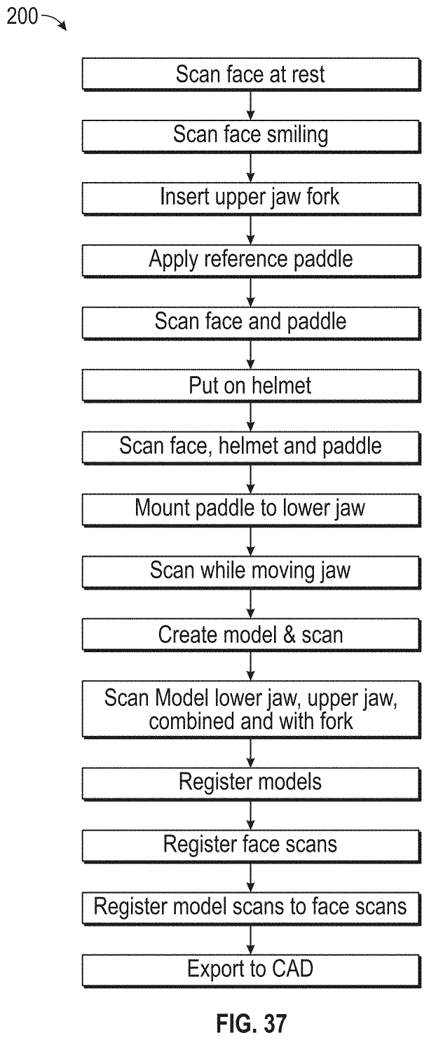

Another method 200 of scanning a patient for a dental procedure is shown in FIG. 37. This method includes scanning a patients face at rest (e.g. mouth closed in a natural or relaxed position) in box 202 to generate a first point cloud. The method then proceeds to block 204 where the patients face is scanned in a “smiling” position to generate a second point cloud. As used herein a smiling position is where the patient forms their features into a pleased, kind, or amused expression, typically with the corners of the mouth turned up and the front teeth exposed. The method 200 then proceeds to block 206 where the tray 118 is placed in the patients mouth against the upper teeth to form an impression in the impression material 120. The paddle 124 is attached to the tray 118 (such as via arm 122) in block 208.

With the paddle 124 in place, the patients face and the paddle 124 are scanned with the 3D scanner to generate a third point cloud. With the tray 118 still in the patients mouth and the paddle 124 positioned in front of the patients mouth, the helmet 132 is placed on the patients head in block 212. The method 200 then proceeds to block 214 where a scan is performed with the 3D scanner of the patients face, the helmet 132 and the paddle 124 to generate a fourth point cloud in block 214.

The method 200 then proceeds to block 216 where the paddle 124 is mounted to the patients lower jaw, such as by attaching the end of the arm 123 (FIG. 11) to the patients tooth 142. The method 200 then proceeds to block 218 where a 3D scan is performed with the 3D scanner of the paddle 124 as the patients jaw is moved from a first position to a second position. In an embodiment, the 3D scanner tracks the position of the targets 126 as the jaw is moved. In an embodiment, the position of the targets 126 is determined on a periodic basis (e.g. 60 frames per second) or on an aperiodic basis. In an embodiment, the movement in block 218 may be performed multiple times with the jaw being moved in a different direction each time. In an embodiment, the movement may be a lateral right; a lateral left; a protrusion, a retrusion, a mouth opening, or a free movement.

The method 200 then moves to block 220 where a physical model 146, 148 is made of the patients upper teeth and lower teeth. The model may be made for example, by casting a material into the impression material in tray 118. With the models made, a replica of the patients teeth was created (FIG. 21-23). The method 200 then proceeds to block 222. In this step, the 3D scanner is used to scan the lower jaw, the upper jaw, and the combination of the upper jaw and lower jaw, with a point cloud being generated for each. In an embodiment, the tray 118 with the paddle 124 attached is placed between the lower jaw and the upper jaw and an additional scan is performed with the 3D scanner to generate a point cloud.

The method 200 then proceeds to block 224 where the point clouds generated in block 222 are registered together. The method 200 then proceeds to block 226 where the point clouds of the patients face from block 202 and block 204 are registered together. The method 200 then proceeds to block 228 where the registered model point clouds (from block 224) are registered with the patient face point cloud (from block 226). The method 200 then proceeds to block 230 where the the registered scan data (patient's face and models) may be exported to a dental CAD system, such as ExoCAD for example. In an embodiment, the movement data from may be included in the data export to allow the movement of the jaw to be simulated. It should be appreciated that the CAD system may be then used to simulate, design, display, and visualize a dental procedure and the patient may be shown the how the procedure will look when completed.

It should be appreciated that while embodiments herein may refer to a single 3D scanning device, this is for example purposes and the claims should not be so limited. In some embodiments, multiple 3D scanning devices may be used, for example a first 3D scanning device (e.g. an area or structured light scanner) may be used to scan the patient, the a second 3D scanning device (e.g. a line scanner or laser line probe) may be used to scan the models of the patients teeth. It is contemplated that multiple 3D scanning technologies may be used cooperatively to measure the patient and the models.

The term “about” is intended to include the degree of error associated with measurement of the particular quantity based upon the equipment available at the time of filing the application. For example, “about” can include a range of ±8% or 5%, or 2% of a given value.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection.” It should also be noted that the terms “first”, “second”, “third”, “upper”, “lower”, and the like may be used herein to modify various elements. These modifiers do not imply a spatial, sequential, or hierarchical order to the modified elements unless specifically stated.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A method of providing visualization and simulation of a dental procedure, the method comprising:
in a first instance, scanning a patients face with a three-dimensional (3D) scanning device to generate a first point cloud;
inserting a device in the patients mouth, the device having a tray with an impression material disposed thereon, a paddle is operably coupled to the tray, the paddle having a plurality of targets thereon;
in a second instance, scanning the patients face with the 3D scanning device with the device inserted to generate a second point cloud;
in a third instance, scanning a model of the patients teeth with the 3D scanning device based at least in part on the impression material to generate a third point cloud;
registering the third point cloud to the first point cloud based at least in part on the second point cloud; and
displaying the registered third point cloud and first point cloud on a display.

2. The method of claim 1, further comprising:
inserting the device onto the model; and
in a fourth instance, scanning the model and the device with the 3D scanning device and generating a fourth point cloud,
wherein the registering of the third point cloud and first point cloud is further based at least in part on the fourth point cloud.

3. The method of claim 1, further comprising:
placing a helmet on the patients head after scanning the patients face with the device inserted, the helmet having at least one member having a plurality of targets;
in a fifth instance, scanning the patient and the helmet with the 3D scanning device to generate a fifth point cloud,
wherein the registering of the third point cloud and the first point cloud is based at least in part on the fifth point cloud.

4. The method of claim 1, further comprising affixing an arm to at least one tooth, the arm having a second paddle with a plurality of targets thereon.

5. The method of claim 4, further comprising:
moving the patients jaw; and
scanning the patient and the second paddle with the 3D scanning device while the patients jaw is moving to determine the position of the second paddle during movement.

6. The method of claim 5, wherein second paddle is the paddle.

7. The method of claim 5, wherein the movement of the jaw is a movement to one or more of directions comprising: a lateral right; a lateral left; a protrusion, a retrusion, a mouth opening, or a free movement.

8. The method of claim 1, wherein the registration of the third point cloud to the first point cloud is based at least in part on at least one of a best fit based on natural features and an Iterative Closest Point (ICP) method.

9. A system for visualization and simulation of a dental procedure for a patient, the system comprising:
a 3D scanning device configured to optically measure coordinates on surfaces to generate a point cloud;
a device having a tray and a paddle, the tray having an impression material, the paddle having a plurality of targets thereon;
one or more processors responsive to executable computer instructions for performing a method comprising:
in a first instance, scanning the patients face with the 3D scanning device to generate a first point cloud;
inserting the device in the patients mouth;
in a second instance, scanning the patients face with the 3D scanning device with the device inserted to generate a second point cloud;
in a third instance, scanning a model of the patients teeth based at least in part on the impression material with the 3D scanning device to generate a third point cloud;
registering the third point cloud to the first point cloud based at least in part on the second point cloud; and
displaying the registered third point cloud and first point cloud on a display.

10. The system of claim 9, wherein the method further comprises:
in a fourth instance, scanning the model with the device inserted on the model with the 3D scanning device and generating a fourth point cloud,
wherein the registering of the third point cloud and first point cloud is further based at least in part on the fourth point cloud.

11. The system of claim 9, further comprising:
a helmet sized to fit on the patients head, the helmet having at least one member with a plurality of targets disposed thereon;
wherein the method further comprises:
in a fifth instance, scanning the patient and with the helmet disposed on their head with the 3D scanning device to generate a fifth point cloud,
wherein the registering of the third point cloud and the first point cloud is based at least in part on the fifth point cloud.

12. The system of claim 9, further comprising an arm a first end and a second end, the first end being configured to attach to a tooth of the patient, the second end being attached to a second paddle, the second paddle having a plurality of targets thereon.

13. The system of claim 12, wherein the method further comprises:
scanning with the 3D scanner the patient and the second paddle with the 3D scanning device while the patient moves their jaw; and
determining the position of the second paddle while the patient moves their jaw.

14. The system of claim 13, wherein the movement of the jaw is a movement to one or more directions comprising: a lateral right; a lateral left; a protrusion, a retrusion, a mouth opening, or a free movement.

15. The system of claim 9, wherein the registration of the third point cloud to the first point cloud is based at least in part on at least one of a best fit based on natural features and an Iterative Closest Point (ICP) method.

16. A method of providing visualization and simulation of a dental procedure, the method comprising:
scanning with a noncontact 3D scanner the patients face at rest to generate a first point cloud;
scanning with the noncontact 3D scanner the patients face smiling to generate a second point cloud;
inserting a device in the patients mouth, the device having a tray with a first impression material disposed thereon, the tray being disposed against the patients upper jaw, a paddle is operably coupled to the tray, the paddle having a plurality of targets thereon;
scanning the patients face with the tray disposed on the patients upper jaw with the noncontact 3D scanner to generate a third point cloud;
inserting the device in the patients mount with tray having a second impression material disposed thereon, the tray being disposed against the patients lower jaw;
scanning the patients face with the tray disposed on the patients lower jaw with the noncontact 3D scanner to generate a fourth point cloud;
generating a first physical model of the patients teeth based in part on the first impression material;
generating a second physical model of the patients teeth based in part on the second impression material;
scanning with the first physical model with the with the noncontact 3D scanner to generate a fifth point cloud;
scanning the second physical model with the with the noncontact 3D scanner to generate a sixth point cloud;
scanning a combination of the first physical model and second physical model with the with the noncontact 3D scanner to generate a seventh point cloud;
registering the first point cloud and the second point cloud based at least in part on the third point cloud and the fourth point cloud;
registering the fifth point cloud and sixth point cloud based at least in part on the seventh point cloud;
registering the registered first point cloud and the second point cloud with the registered fifth point cloud and sixth point cloud; and
displaying the registered first point cloud, second point cloud, fifth point cloud and sixth point cloud on a display.

17. The method of claim 16, further comprising:
scanning a combination of the first physical model and second physical model with the tray operably disposed on one of the upper jaw or lower jaw with the with the noncontact 3D scanner to generate an eighth point cloud, and
wherein the registration of the registered first point cloud and the second point cloud with the registered fifth point cloud and sixth point cloud is based at least in part on the eighth point cloud.

18. The method of claim 17, further comprising:
placing a helmet on the patients head after scanning the patients face with the device inserted, the helmet having at least one member having a plurality of targets; and
scanning the patient and the helmet with the noncontact 3D scanner to generate a ninth point cloud,
wherein the registration of the registered first point cloud and the second point cloud with the registered fifth point cloud and sixth point cloud is further based at least in part on the ninth point cloud.
